(19) United States
(12) Patent Application Publication
(10) Pub. No.: US 2019/0130281 A1
(43) Pub. Date: May 2, 2019

(54) NEXT CAREER MOVE PREDICTION WITH CONTEXTUAL LONG SHORT-TERM MEMORY NETWORKS

(71) Applicant: Microsoft Technology Licensing, LLC, Redmond, WA (US)

(72) Inventors: Jaewon Yang, Sunnyvale, CA (US); Qi He, San Jose, CA (US); How Jing, Sunnyvale, CA (US); Bee-Chung Chen, San Jose, CA (US); Liangyue Li, Chandler, AZ (US)

(21) Appl. No.: 15/799,396

(22) Filed: Oct. 31, 2017

(51) Int. Cl. G06N 5/02

(52) U.S. Cl. CPC G06N 5/02; G06T 11/206

(57) ABSTRACT

Techniques for predicting a next company and next title of a user are disclosed herein. In some embodiments, an encoder is used for encoding a representation of the user's profile. The encoding includes accessing discrete entities comprising context information included in the user's profile, constructing a plurality of embedding vectors from the context information, and generating a context vector from the plurality of embedding vectors. The plurality of embedding vectors including a skill embedding vector, a school embedding vector, and a location embedding vector. A decoder is for decoding a career path from the context vector. The decoding includes applying a long short-term memory (LSTM) model to the context vector to generate perform the prediction of the user's next company and next title for presentation in a user interface.

### TECHNICAL FIELD

The present application relates generally to machine learning and, in one specific example, to methods and systems for improving predictions of next career moves of people and surfacing such improved predictions in one or more specialized user interfaces.

### BACKGROUND

With increased globalization and labor mobility, human resource reallocation across firms, industries, and regions has become the new norm in labor markets. The emergence of massive digital traces of such mobility offers a unique opportunity to understand labor mobility at an unprecedented scale and granularity. While studies on labor mobility have largely focused on characterizing macro-level (e.g., region or company) or micro-level (e.g., employee) patterns, the problem of how to accurately predict one or more next career moves of a person (e.g., to which companies and to which job titles) has received little attention.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating an architecture for a prediction system, in accordance with an example embodiment.

FIG. 4 is a flowchart of an example method for encoding a context representation.

FIG. 5 is a flowchart of an example method for decoding a context vector.

FIGS. 6A and 6B are graphs of example user interface outputs pertaining to performance with varying embedding sizes of the comparison methods in a dataset.

FIGS. 7A and 7B are graphs of example user interface outputs pertaining to performance with varying popularity of target company/title in a dataset.

FIGS. 8A and 8B are graphs of example user interface outputs pertaining to performance with varying seniority of a member in a dataset.

FIG. 9 is a screenshot of an example user interface in which a prediction of a user's next company and next title is presented.

FIG. 10 is a block diagram illustrating a mobile device, in accordance with some example embodiments.

FIG. 11 is a block diagram of an example computer system on which methodologies described herein may be executed, in accordance with an example embodiment.

### DETAILED DESCRIPTION

Example methods and systems of improving predictions of next career moves and surfacing such predictions in one or more specialized user interfaces are disclosed. In the following description, for purposes of explanation, numerous specific details are set forth in order to provide a thorough understanding of example embodiments. It will be evident, however, to one skilled in the art that the present embodiments may be practiced without these specific details.

Quantifying and modeling labor mobility may involve combining a search model with a matching model to identify reasons behind worker movements from job to job as well as into and out of the labor markets. For example, a move may result from changes in the perceived value of the worker's market opportunities. Labor force survey data may be examined to establish several key facts regarding properties of labor market flows, including transition probabilities between employment, unemployment, and inactivity. Tools from network science may be brought into economics to characterize the properties of the labor flow network among different companies and to identify firms with high growth potential. With the availability of massive datasets pertaining individual career paths, large-scale studies of the labor flow have become possible. For example, academia, as a particular job market, exhibits a unique career movement pattern that is characterized by a high degree of stratification in institutional ranking. The impact of movement on a scientist's research performance may also be quantified. Job recommendations with emphasis on tenure may be effective in improving the utility of the system (e.g., making the recommendation at the right time when the user is likely to change the job may be critical). Career trajectories can be employed as professional similarities between two individuals by first aligning the sequences and then extracting the temporal and structural features. The accuracy of a prediction of a next career move can be improved by improving the quality and quantity of data upon which the prediction is based. For example, using full career trajectories (e.g., instead of portions of profile data) of members of a social network or using millions of records (e.g., instead of thousands) is likely to produce better results.

Representation learning aims to learn good feature representation for input entities without hand-crafting rules. It has shown promising results in many application domains, ranging from natural language processing (NLP) to network science to health care. In NLP, a skip-gram model learns embedding for words by predicting a word's surrounding words and the embeddings learned exhibit linguistic regularities that have analogy to algebraic operations.

The task of fine-grained entity type classification can also be addressed by embedding methods on labels. In computer vision, multi-model concept representations from the concatenation of linguistic representation vectors and visual concept representation vectors have a substantial performance gain on some semantic relatedness evaluation tasks. The image and sentence embeddings can also be jointly learned in the same space and is shown to be effective for ranking images and descriptions and is able to capture multi-model regularities. Network science can be used to learn embeddings for vertices in a network that can encode the structural relations. For example, DeepWalk applies a skip-gram model to the truncated random walks to achieve improvements in multi-label classification tasks on social networks. Richer representations can be learned through a biased random walk procedure. For example, LINE learns network embeddings by optimizing a carefully-designed objective function that preserves both first-order and second-order proximities. Physical locations with spatial and temporal contexts can be modeled using a recurrent model for the next location predictions and the performance of next basket recommendation can be enhanced through embedding of dynamics of baskets of items.

Large-scale experiments may be used to improve predictions of next career moves. For example, two sources of predictive signals may be focused on: profile context matching and career path mining. A contextual Long Short-Term Memory (LSTM) model and corresponding modules or applications (e.g., NEMO) may simultaneously capture signals from both sources by jointly learning latent representations for different types of entities (e.g., employees, skills, or companies) that appear in different sources. In particular, NEMO may generate a contextual representation by aggregating profile information and exploring dependencies in the career paths through LSTM networks. Extensive experiments on a large, real-world dataset may be used to adapt NEMO such that it significantly outperforms strong baselines and also reveals interesting insights in micro-level labor mobility. These insights may, in turn, be surfaced in one or more specialized user interfaces, as described in more detail below.

Labor flow is a vehicle that matches supply with demand, stimulates circulation of knowledge at the regional and international scale and proves to be a forceful driver of innovation. Given access to digital traces of labor flows at an ever-larger scale, it is possible to develop a deeper understanding the dynamics of employees' career moves and the implications on the economy at both micro and aggregate levels, instead of just with respect to macro-level analysis (e.g., regions, companies) or characterizing of micro-level (e.g., individuals) labor mobility patterns.

At the macro level, employer-to-employer flows are discovered to be procyclical and concentrated among frequent job changers. The labor flow network identifies firms with high growth potential through the lens of network science. At the micro level, the career moves of scientists across institutions are analyzed, and how the moves shape and affect individual's performance is quantified (e.g., in accordance with scholarly data).

In the recommendation domain, job recommendation models are built based on whether a user clicks or applies for recommended jobs. The problem of how to predict an individual's actual next job position (e.g., not whether he/she clicks or applies for a job) has received relatively little attention. A large-scale analysis and application for predicting next career moves (e.g., which company with what job title) based on millions of users is disclosed herein. By modeling each individual differently, better prediction accuracy can be achieved and more personalized recommendations can be provided to each individual.

Building a personalized predictive model for an individual's career may be a challenging problem because there may be many factors behind a career move, such as educational background, skill set, previous job history, and so on. Two types of signals may be focused on, as discussed below.

First (profile context matching), the predicted next career move should reflect an individual's profile information, such as skills, education, and so on; otherwise, the so-called skills gap might get in the way. For example, an experienced engineer might find it difficult to be competent for an accountant position. The profile attributes can also mitigate a cold-start problem, where no career history is observed for new users.

Second (career path mining), the predicted next career move should reflect the trajectory of one's own past career path. For example, the knowledge and experience accumulated along the way prepares a job seeker for the next move and it is very rare for one to switch to an entirely new field. Having known a user's past position being a software engineer at Microsoft may tell much about what the next position is likely to be.

To build a predictive model using the profile attributes and career paths, a challenge is how to integrate these heterogeneous signals. On the member profile side, there may be categorical attributes that are high dimensional. For example, there are millions of companies, but more than half of them have less than 50 employees. Moreover, some attributes are single-valued per member (e.g., final education), while other attributes are multi-valued (e.g., skill set). On the career-path side, there may be a sequence of job positions (e.g., company and job title). A comprehensive model that can handle both signals is needed.

To simultaneously capture the two types of signals, NEMO uses a encoder-decoder architecture that can learn effective latent representations/embeddings for the objects (e.g., skills or companies). In particular, the encoder maps multiple heterogeneous profile attributes into a fixed-length context vector. Concretely, the model first generates the representation for the employee's skill sets by aggregating the embeddings of the skills that the employee has, and then further aggregates the skill set representation with that of the employee's education and location representations. The resulting combined representation is the employee's context vector. The decoder, on the other hand, maps the context vector to the employee's sequence of positions. An LSTM recurrent neural network is taken advantage of to pass along the long-term dependencies from the previous positions. Specifically, the employee's context vector is used as the initial state of the LSTM network to generate the career path. The hidden states in LSTM capture not only the contextual information, but also the dynamics along one's career path. Thus, the proven capability of LSTM in forming implicit compositional representations over sequences is applied.

Large-scale experiments for predicting career moves of individuals using a dataset with millions of members of a social network are then conducted. First, by using signals from both the profile context and career path, the performance of NEMO is measured relative to a number of strong baselines for predicting the next career move. For example, the importance of these signals in making accurate predictions is empirically analyzed. Second, the model, which is trained end-to-end without injecting any prior knowledge, uncovers insightful patterns from large-scale analysis, which are then surfaced in one or more specialized user interfaces.

In example embodiments, an encoder is used for encoding a representation of a user profile. The encoding includes accessing discrete entities comprising context information included in the user profile, constructing a plurality of embedding vectors from the context information, and generating a context vector from the plurality of embedding vectors. The plurality of embedding vectors includes a skill embedding vector, a school embedding vector, and a location embedding vector. A decoder is used for decoding a career path from the context vector. The decoding includes applying a long short-term memory (LSTM) model to the context vector to generate perform the prediction of the user's next company and next title for presentation in a user interface.

in example embodiments, one or more modules are incorporated into a social networking system, the one or more modules specially-configuring (e.g., through computer programming logic) one or more computer processors of the social networking system to perform one or more of the operations described herein.

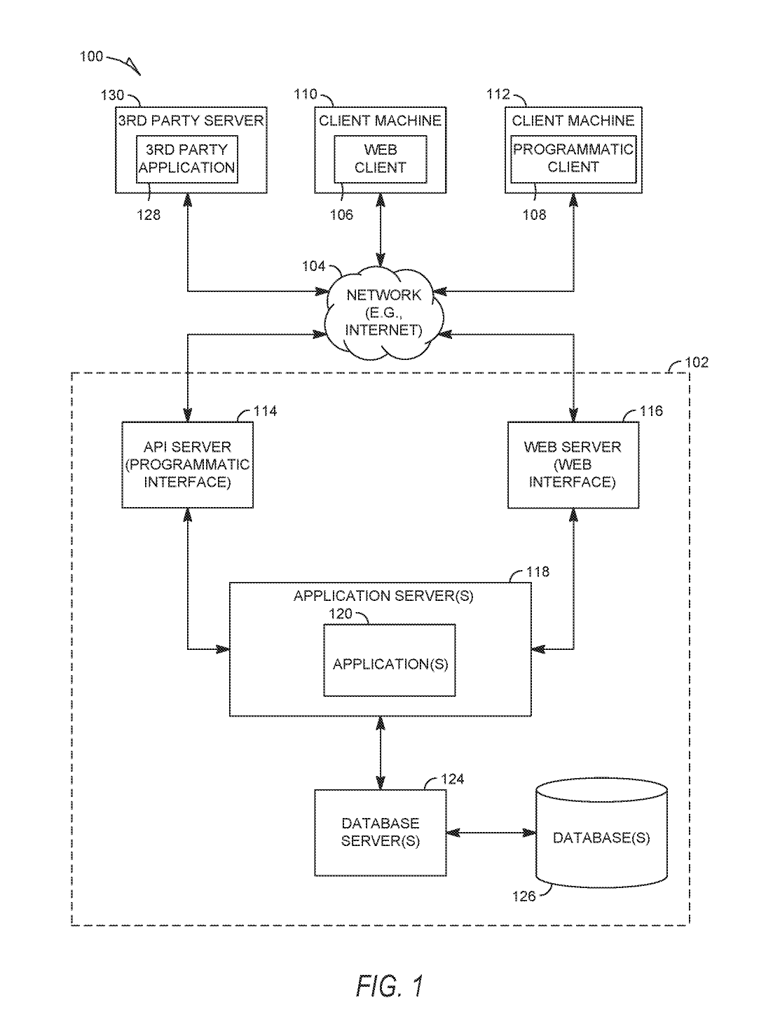

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third-party application 128, executing on a third-party server machine 130, as having programmatic access to the networked system 102 via the programmatic interface provided by the API server 114. For example, the third-party application 128 may, utilizing information retrieved from the networked system 102, support one or more features or functions on a website hosted by the third party. The third-party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device. In some embodiments, the networked system 102 may comprise functional components of a social networking service.

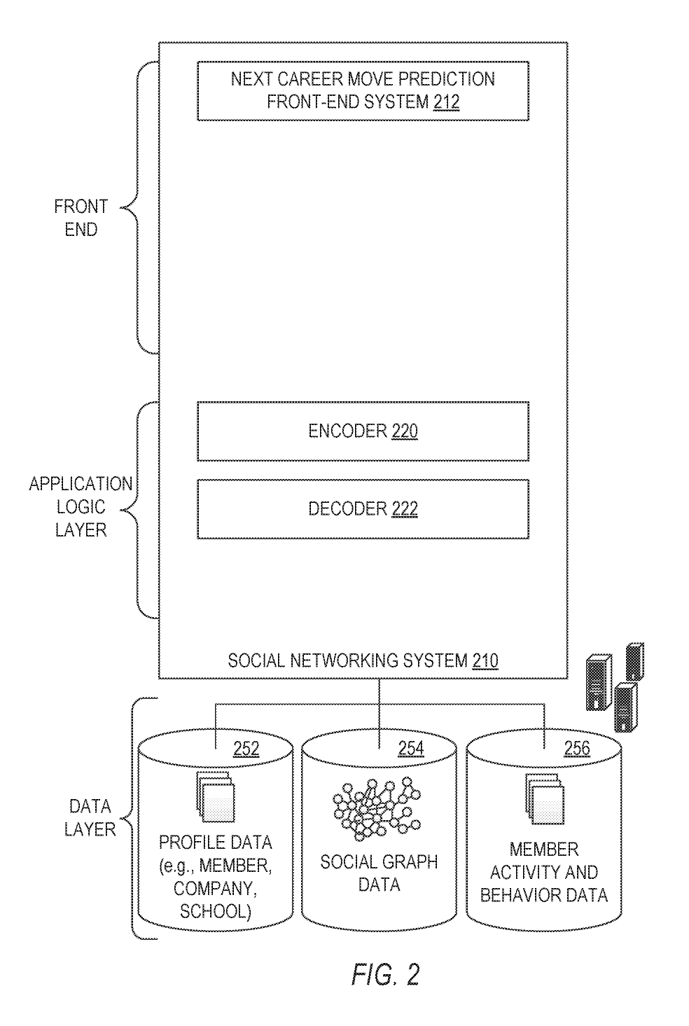

FIG. 2 is a block diagram showing the functional components of a social networking system 210, for use in social networking system 210, consistent with some embodiments of the present disclosure. In some embodiments, the functional components reside on application server(s) 118 in FIG. 1. However, it is contemplated that other configurations are also within the scope of the present disclosure.

As shown in FIG. 2, the functional components include a next career move prediction front-end system 212, an encoder 220, and a decoder 222.

An application logic layer may include one or more various application server modules, which, in conjunction with the user interface module(s), generate various user interfaces (e.g., web pages) with data retrieved from various data sources in the data layer. With some embodiments, application server modules are used to implement the functionality associated with various applications and/or services provided by the social networking service. In example embodiments, the front end includes a next career move prediction front-end system 212 and the application logic layer includes an encoder 220 and a decoder 222.

As shown in FIG. 2, a data layer may include several databases, such as a database 252 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 252. Similarly, when a representative of an organization initially registers the organization with the social networking service, the representative may be prompted to provide certain information about the organization. This information may be stored, for example, in the database 252,or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 254.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 256. This logged activity information may then be used by the social networking system 210.

In some embodiments, databases 252, 254, and 256 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the front-end and back-end systems are referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

### Problem Definition

In a large-scale professional social network, many millions of members can create professional profiles and seek jobs. Users can share their working experience by reporting the employers they have worked for. Specifically, a user u's working experience can be summarized as J^{u}={J₁^{u},J₂^{u}, . . . , Jₙ^{u}}, where Jᵢ^{u} is user u's i'th job position, denoted by a tuple, i.e., Jᵢ^{u}=(lₛ^{u},cᵢ^{u},tᵢ^{u}), indicating that user u worked at company cᵢ^{u} with title lᵢ^{u} starting from time tᵢ^{u}. In addition to working experience, users can also add skills to their profiles or get their skills endorsed. For example, a user might be good at Data Mining; Machine Learning and Pattern Recognition. User u's skills set is denoted by S^{u}={s₁, s₂, . . . , sₘ}, where each is a specific skill, e.g., Hadoop. The user can also report their education background in their profile. The user's location (e.g., San Francisco Bay Area) is denoted by r^{u}. For simplicity, a subset of profile information (e.g., a user u's highest education institute) may be used and denoted by h^{u}. Let U, L, C, K, H, R be the collections of all users, titles, companies, skills, schools and locations. Note that all the entities (e.g., titles, companies) may be standardized (e.g., two different titles Senior Software Engineer and Sr. Software Engineer may be mapped to the same item in L. In this disclosure, bold lowercase letters may be used for vectors (e.g. w), bold upper-case letters for matrices W). Also, the elements in a matrix may be represented using a convention similar to Matlab (e.g., W(;, j) is the j'th column matrix W).

With the above notations, the problem of predicting each individual's next career move can be formally defined as follows:

Given: the working experience of all users J^{u}^{ₛ}, J^{u}^{ₛ}, . . . J^{u|U|}, observed up to a timestamp T, the skills set S^{u}^{₁},S^{u}^{₂}, . . . S^{u|U|}, the education institutes h^{u}^{₁}, h^{u}^{₂}, . . . h^{u|U|} and the locations r^{u}^{₁}, r^{u}^{₂}, . . . r^{u|U|} of all users.

Predict: the user's next career move, including title l|ⱼ_{^{u}}_{|+1}^{u} ∈ L, company c_{|f}_{^{u}}_{|+1}^{u} ∈ C, after time T.

From the prediction perspective, leveraging all the information available in the user's member profile may be focused on. In example embodiments, two design objectives are sought to be achieved, as described below.

Profile context matching: Three salient sections in members' profiles that are indicative of users' careers are Skills, Education, and Location. First, skills are assets of individuals and different jobs have different requirements for skills. Matching skills and jobs may be a high-priority policy concern. For instance, an individual with strong skills in machine learning and data mining is more likely to move to a research scientist position in a high-tech company than an accountant position at a bank. Another important attribute that may be considered is education. For example, a Carnegie Mellon University graduate might have a higher chance to work in the tech industry in comparison to a university best known for its law major. Additionally, locations of job seekers may also bias where the job seekers would eventually go. For example, companies in the Bay Area may be generally more attractive to Bay Area job seekers compared to New York-based companies. Being able to incorporate this contextual information may be important for matching top talents and companies. For simplicity, it may be assumed that these profile attributes are static and fixed.

Career path mining: Another important signal for the career move may be a user's current position. It may be natural to assume that the next position is highly correlated to the current one and incorporating this information may show improvement upon static methods. However, most professionals might have more than one job throughout their career history, and considering only the last position may miss the bigger picture of one's professional life. It may be knowledge and experiences built up through one's entire career history that prepares the candidate for future opportunities. Thus, it may be desirable to learn the entire career trajectory in order to infer the next move.

### An Encoder-Decoder Architecture

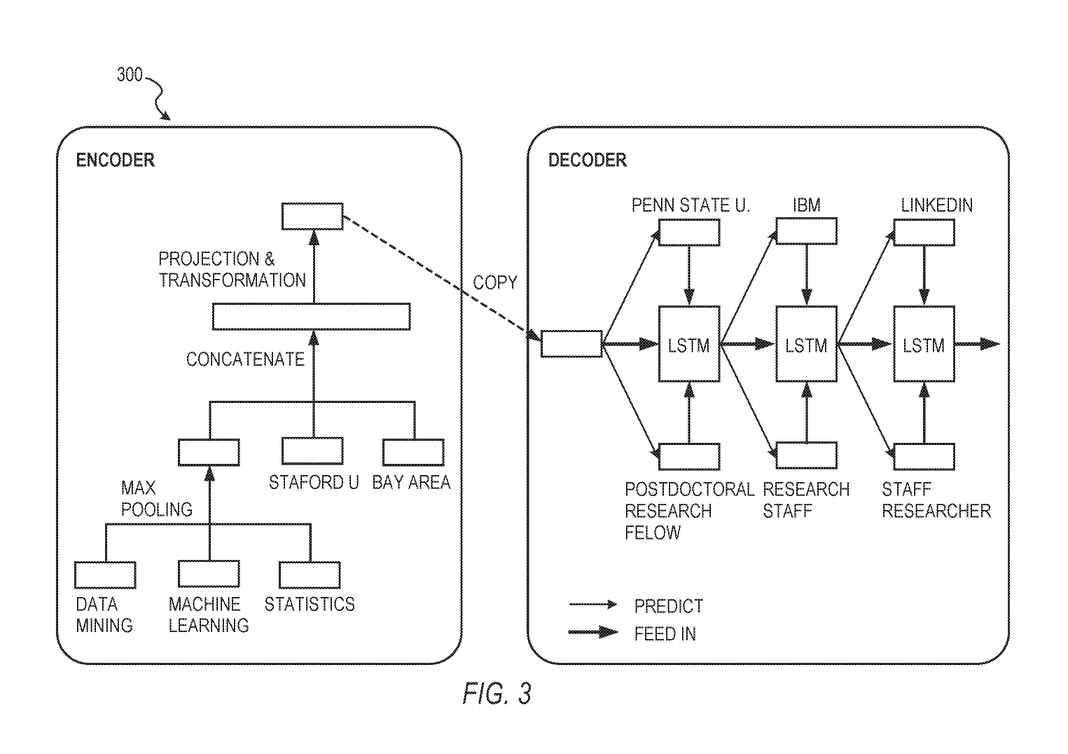

FIG. 3 is a block diagram of an example embodiment of an encoder-decoder architecture designed to solve the problem defined above. An encoder maps multiple heterogeneous profile contexts into a fixed-length vector, which is referred to as context vector, and a decoder maps the context vector to a sequence of positions. This neural network model is configured to compute the conditional probability of the output career path given an input user's profile information. In example embodiments, the architecture may be thought of as being analogous to a machine-translation framework where one encodes a source language sequence to a vector and then decodes to the target language sequence.

### Encoding a Context Representation

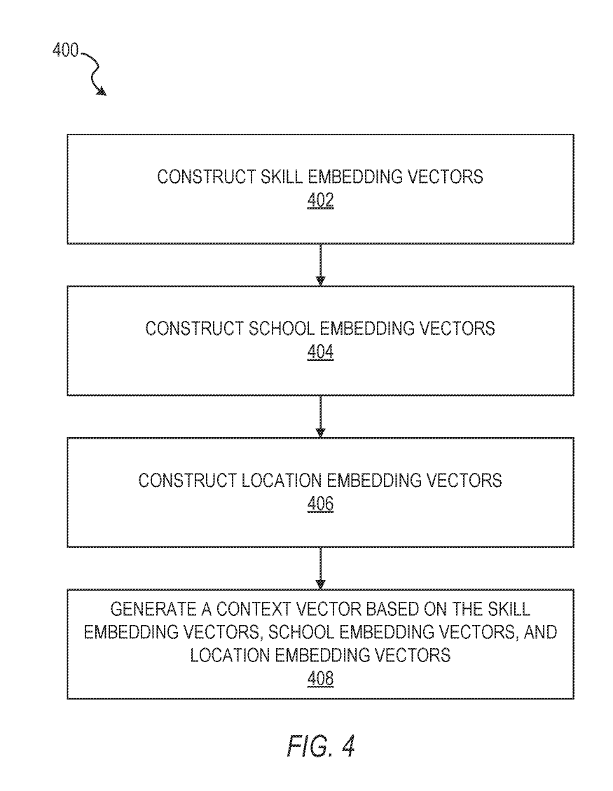

FIG. 4 is a flowchart of an example method 400 for encoding a context representation. Encoding may include learning a compact representation of the context information from user profiles. The attributes may usually be high-dimensional categorical features that bear no notion of similarity and do not generalize well. One way to encode these discrete entities is to use embeddings (e.g., as in distributed representations of words in natural language processing tasks).

In example embodiments embeddings for user profile attributes are constructed in the following manner. Skill embeddings are constructed at 402. Let {s₂^{u}, s₃^{u}, . . . , sₘ^{u}} be the set of user u's skills embeddings. Note that users may have different numbers of skills, from as few as one skill to more than 20 skills. To ensure that each user has embeddings with the same dimension, a pooling method may be used across skill embedding vectors. In particular, for example, max-pooling may be used to get a single skill vector,

s^{u}=max(s₂^{u},s₃^{u}, . . . , sₘ^{u})

where max is applied dimension-wise. A user's top skills might dominate more in the career move and max operation allows the model to completely ignore irrelevant skills. Note that other pooling methods, such as average pooling, may also be used. Next attributes may include a user's school and location, for which school embeddings are constructed at 404 and location embeddings are constructed at 406. These embeddings are concatenated with skill embedding, and fed through a one-layer neural network as follows:

vᵤ=tan h(Wᵥ[s^{u},h^{u},r^{u}]^{T}+bᵥ)

where h^{u}, r^{u} are the user's school and location embeddings respectively, [ [symbol] ] concatenates the vectors, and Wᵥ and bᵥ are the projection matrix and bias vector, respectively. A hyperbolic tangent is used as it aligns with the activation function of the LSTM output state. The final output vᵤ from the encoder captures the correlations of user's skills, school, location and serves as the representation of user's profile at 408. Vector vᵤ may be called the context vector for user u.

Decoding with Long-Short Term Memory Networks

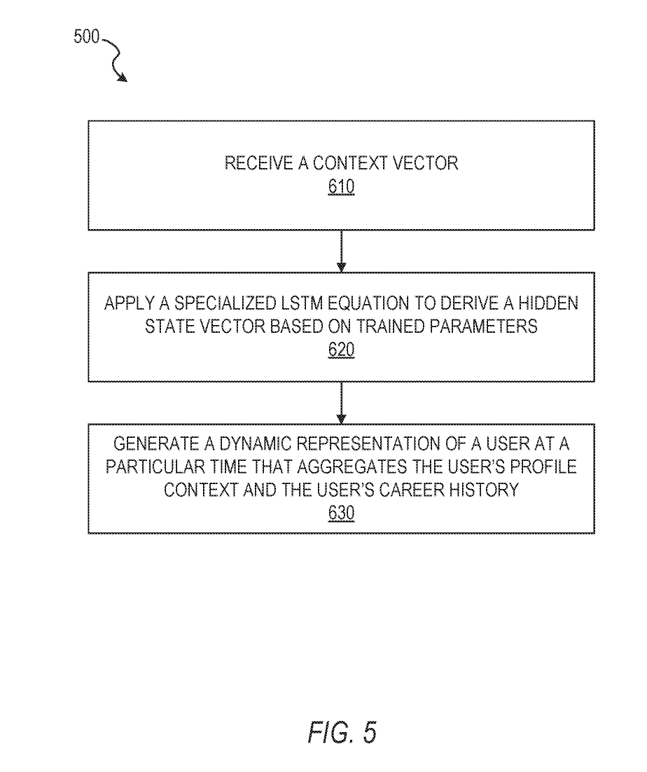

FIG. 5 is a flowchart of an example method 500 for decoding a context vector. In order to decode one's career path from the context vector learned and received at 610, a Recurrent Neural Network (RNN) is taken advantage of due to its usefulness in modeling sequential data. In particular, LSTM is employed, as a particular type of RNN, to address the problem of vanishing gradients. LSTM is capable of exploiting longer range of temporal dependencies in the sequences, such as in tasks related to sequence learning and image caption generation. Many variants of LSTM architecture may be used. In example embodiments, at 620 the following LSTM equation is used:

iₜ=σ(Wᵢₓxₜ+Wᵢₘmₜ₋₁)

fₜ=σ(W_{fx}xₜ+w_{fm}mₜ₋₁)

oₜ=σ(Wₒₓxₜ+Wₒₘmₜ₋₁)

eₜ=f₂ ⊙ eₜ₋₁+iₜ ⊙ tan h(W_{cx}xₜ+W_{cm}mₜ₋₁)

mₜ=oₜ ⊙ eₜ (1)

where ⊙ is the element-wise multiplication, xₜ is the input data (e.g., the embeddings of company and title) at time step t; iₜ, fₜ, oₜ serve as input gate, forget gate, output gate, respectively, the various W matrices are the trained parameters, and mₜ is the hidden state at time step t. The hidden state vector mₜ can be viewed as the dynamic representation of a user at time t that aggregates the user's profile context as well as the user's career history up to t.

### Learning and Prediction

In example embodiments, the architecture a combined encoder-decoder network and the entire model is trained end-to-end to maximize the log probability of generating the correct career path given the observed user's context information:

Θ^{*}=arg max_{Θ}=Σᵤ log p(J^{u}|S^{u}, h^{u}, r^{u})

where Θ are all of the model parameters, including all the entity embeddings and parameters in LSTM. Suppose a particular user u's T jobs have been observed; the log probability for that user's career path further decomposes into,

$$log p ( {J}^{u} \vert {S}^{u} , {h}^{u} , {r}^{u} ) = {\sum }_{t = 1}^{T} log p ( {J}_{t}^{u} \vert {S}^{u} , {h}^{u} , {r}^{u} ) = {\sum }_{t = 1}^{T} [ log p ( {c}_{t}^{u} \vert {S}^{u} , {h}^{u} , {r}^{u} {c}_{{t}^{′} < t}^{u} , {l}_{{t}^{′} < t}^{u} ) + log p ( {l}_{t}^{u} \vert {S}^{u} , {h}^{u} , {r}^{u} , {c}_{{t}^{′} < t}^{u} , {l}_{{t}^{′} < t}^{u} ) ] \qquad ( 2 )$$

where cₜ_{^{f}}_{≤t}^{u} and Iₜ_{^{f}}_{<t}^{u} are the user's previous t−1 companies and titles. Note that cₜ^{u} and lₜ^{u} may be assumed to be conditionally independent of each other given everything observed up to time t−1. To get the probability distribution p(cₜ^{u}|S^{u}, h^{u}, r^{u}, cₜ_{^{f}}_{<t}^{u}, lₜ_{^{f}}_{<t}^{u}) over companies, the hidden states vector mₜ may be used from the LSTM and fed into a softmax layer, for example.

$$p ( {c}_{t}^{u} = k \vert {S}^{u} , {h}^{u} , {r}^{u} , {c}_{{t}^{′} < t}^{u} , {l}_{{t}^{′} < t}^{u} ) = \frac{exp ( {{W}_{c} ( : , k )}^{T} {m}_{t - 1} + {b}_{c} ( k ) )}{{\sum }_{{c}^{′} ∈ C} exp ( {{W}_{{c}^{′}} ( : , k )}^{T} {m}_{t - 1} + {b}_{{c}^{′}} ( k ) )}$$

where W_{c}, b_{c} are the softmax weight, bias for company respectively. Similarly mₜ₋₁ may be fed to another softmax to predict title distribution, In other words, multi-task learning is performed to predict the next company and title jointly with a shared representation mₜ₋₁.

However, it may be practically infeasible to directly maximize the log probability in Eq 2 since computing the full softmax would have a cost proportional to the number of companies and titles, which are usually very large. For example, there are in the order of millions of companies in U.S. alone and hundreds of thousands even after aggressive pre-processing. To improve scalability, the “sampled softmax” strategy may be adopted to approximately maximize Eq 2. The basic idea is instead of performing softmax over the entire output space, a subset (e.g., 50) of companies/titles may be randomly sampled softmax may be applied over this much smaller space.

After learning, it may become straightforward to predict the user's next career move. Suppose a user u's career path has been observed until time T and it is desired to predict what u's next company and title would be. The hidden states vector m_{T} may be obtained, which captures all the contextual information and the career path dynamics up until time T. At 630, the next company and title may be predicted using the full softmax to get the full distribution over the next company, title and the top-K most probable results may be selected.

### Measuring Predictive Performance

NEMO not only has a measurable predictive performance, but also allows career trajectories to be sampled from a given member profile. For example, the model essentially defines a probability distribution of a career given a contextual profile. With this generative ability, questions like this may be answered: “what kinds of career path does a Harvard Computer Science graduate have?” Such insights may be useful for students who are applying for graduate schools.

### Empirical Evaluations

To measure predictive performance, experimental evaluations may be used. Experiments may be designed to inspect the following aspects: (1) Effectiveness: how accurate is the proposed NEMO model for predicting next career move? and (2) Insights: what insights can be drawn from the model?

### Dataset

Real-world data from a social networking system (e.g., LinkedIn) may be used to evaluate the proposed model. For example, two datasets may be constructed as follows. (1) Computer, which consists of members from the following industries: “computer software,” “internet,” “computer hardware,” “computer networking,” and “information technology and services”; and (2) Finance, which includes members from the following industries: “banking,” “financial services,” “investment banking,” “investment management.” Industries such as these may be pre-defined (e.g., by the social networking system) for users to choose. The datasets may span a particular date range. During pre-processing, members with fewer than a certain number of positions (e.g., less than 1) or with more than a certain number of positions (e.g., 20) in their profiles may be removed. The maximum number (e.g., 20) may be chosen based on various factors, such as an observed number that correlates to spam users (e.g., who put lots of positions in their profiles), for filtering out inaccurate or fraudulent data. Skills, companies, titles, and schools that appear less than a certain number of times (e.g., 10 times) the dataset may also be removed. The positions (e.g., tuples of company and title) observed in s training range may be used for training the model. The task may be to predict the first new position (i.e., both company and title) after a particular date. Example statistics of the two datasets after preprocessing are summarized in Table 2.

TABLE 2
Statistics for two datasets. Note that only the scale is reported.

| | Computer | Finance |
|---|---|---|
| #members | >1M | >1M |
| #skills | >10K | >10K |
| #companies | >100K | >10K |
| #titles | >10K | >10K |
| #schools | >1K | >1K |
| #locations | >100 | >100 |
| #training positions | >10M | >1M |
| #testing positions | >100K | >100K |

### Experimental Setup

### Evaluation Metric

The Mean Percentile Ranking (MPR) may then be used to evaluate the quality of the prediction. Let Uₜₑₛₜ be the set of members who have a new position during the testing period. The MPR for both the company and title prediction can be computed as follows:

$$MPR ( c ) = \frac{1}{{U}_{test}} {\sum }_{u ∈ {U}_{test}}^{ } \frac{1}{\vert C \vert} rank ( {c}_{u}^{*} )$$

$$MPR ( l ) = \frac{1}{{U}_{test}} {\sum }_{u ∈ {U}_{test}}^{ } \frac{1}{\vert L \vert} rank ( {l}_{u}^{*} )$$

where rank(c*ᵤ) and rank(l*ᵤ) are the rank of user u's actual company c*ᵤ and actual title l*ᵤ, and the rank is obtained by sorting the model's prediction scores. Lower values are more desirable as they indicate the model can rank the true company/title higher in the ranking list. Note that classic classification metrics (precision and recall) are ranking-agnostic, and the Mean Average Precision (MAP) and Normalized Discounted Cumulative Gain (NDCG) at certain ranking positions are too coarse given there is only one ground-truth in the ranking list. 0/1 loss would be too harsh in that it becomes harder to distinguish a good model from a bad one (a model that ranks true company at 2^{nd} position will get the same penalty as a model that ranks it at 200000^{nd} positions under the classification accuracy metric).

### Comparison Methods

The following methods may be compared:

Top: always recommend the most popular company/title.

Bigram: estimate the transition probability using a simple counting method. This is a consistent estimator under the first-order Markov assumption. It is usually a strong baseline when the data is not sparse.

Context Only: use only the contextual information of users without considering the career path to recommend the next position.

MC: Markov Chain sequential model that embeds each company and title into the semantic space and consider only the previous company/title in the prediction phase.

HRM: Hierarchical Representation Model that simply aggregates the embeddings of all the previous companies/titles through max-pooling to make the prediction.

LSTM: use only LSTM to explore the whole career path without the profile context.

NEMO: the context-aware LSTM model described herein, which encodes different contextual information from a member into a latent vector representation, and then learns to decode the member's career trajectory based on this vector.

### Implementation Details

For Top and Bigram, a position may be randomly recommended if multiple positions meet the recommendation criteria. For neural network-based methods, mini-batch SGD with Adagrad acceleration may be used, where the batch size is set to a predetermined number (e.g., 64). The learning rate is also set to a predetermined number (e.g., 0.05 divided by the batch size). In example embodiments, small 12 regularization may be used in each model. The embedding dimension and the number of hidden units are both set to a predetermined number (e.g., 200), with a predetermined number (e.g., 2) for hidden layer for the models. Table 3 provides example quantitative results for company and title for the selected industries.

### Quantitative Results

TABLE 3
Mean percentile rank comparisons on predicting the next title and the next
company.

| | Computer | Computer | Finance | Finance |
|---|---|---|---|---|
| | (Company) | (Title) | (Company) | (Title) |
| Top | 0.1318 | 0.0634 | 0.1098 | 0.0663 |
| Bigram | 0.1054 | 0.0437 | 0.0850 | 0.0518 |
| Context Only | 0.0512 | 0.0286 | 0.0403 | 0.0391 |
| MC | 0.0542 | 0.0277 | 0.0496 | 0.0351 |
| HRM | 0.0519 | 0.0269 | 0.0499 | 0.0369 |
| LSTM | 0.0432 | 0.0225 | 0.0411 | 0.0299 |
| NEMO | 0.0299 | 0.0182 | 0.0260 | 0.0253 |

### Summarized Results

Given the example quantitative results, it may be determined that the NEMO model significantly outperforms all the comparison methods on both datasets. For example, compared to the best baseline LSTM, 30% and 19% relative improvements may be achieved in company and title prediction respectively on Computer.

The example quantitative results also show the effectiveness of the two important ingredients of the model: profile context and career path. Models incorporating the career path (HRM and LSTM) may outperform the models using the last position only (MC and Bigram). Compared with HRM, LSTM may perform better because it models the ordering of the positions, whereas HRM simply aggregates the history. Finally, NEMO may outperform LSTM, showing the importance of modeling context in addition to the position sequences.

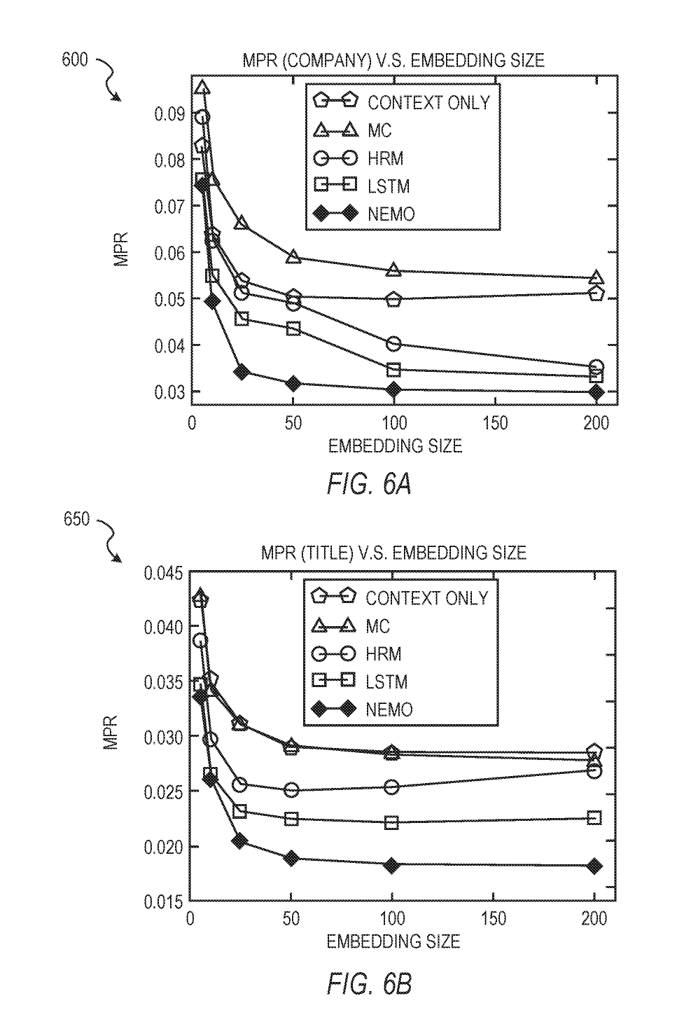

FIGS. 6A and 6B are graphs of example user interface outputs pertaining to performance with varying embedding sizes of the comparison methods in Computer dataset. FIG. 6A graphs performance on company prediction. FIG. 6B graphs performance on title prediction.

Results with Varying Embedding Dimension

How varying the embedding dimension affects the performance of each model on Computer may now be compared in more detail. From FIGS. 6A and 6B, a diminishing return is observed in the performance of all the models. For instance, NEMO with 50 dimensional embeddings performs almost as well as that with 200 dimensions, but enjoys 3 times faster training as well as smaller memory footprint.

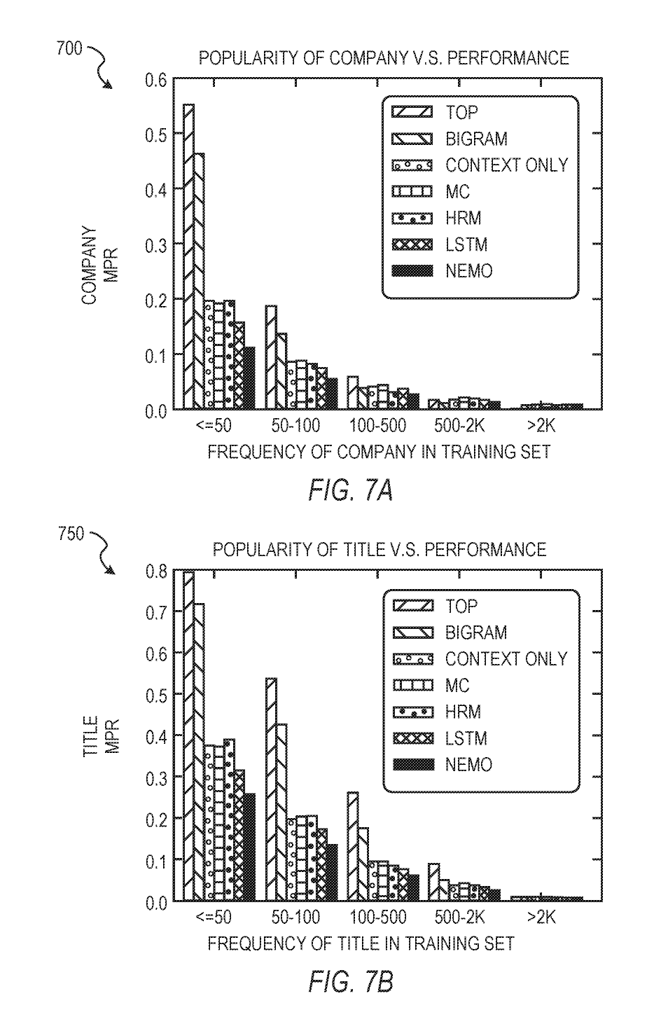

FIGS. 7A and 7B are graphs of example user interface outputs pertaining to performance with varying popularity of target company/title in the Computer dataset. FIG. 7A provides an evaluation on company prediction. FIG. 7B provides an evaluation on title prediction.

### Results Segmented by Position's Popularity

FIGS. 7A and 7B present how performance varies with the popularity of the users' actual company and title in Computer. As can be seen, the improvement of NEMO may be especially dramatic when the target company/title is rare, in which case Bigram might fail due to insufficient data for estimating the transition probabilities. On the other end, all models have a small MPR for predicting very popular targets.

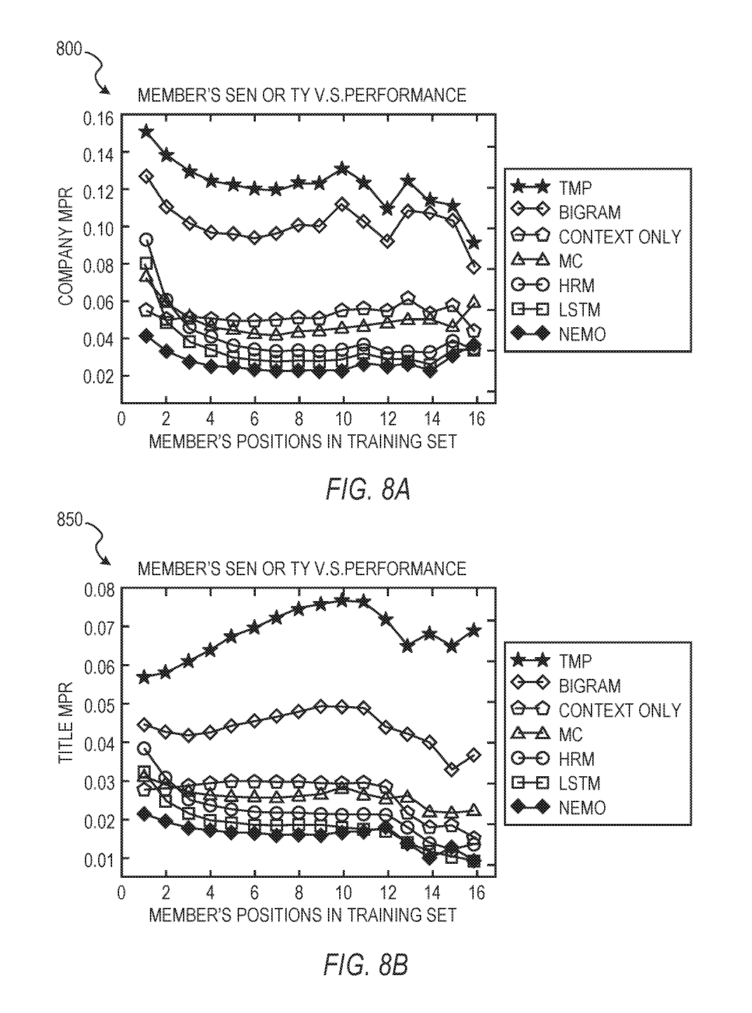

FIGS. 8A and 8B are graphs of example user interface outputs pertaining to performance with varying seniority of a member in Computer. Members are stratified into different buckets by the number of position they have in the past. The average MPR is shown for each bucket. FIG. 8A provides an evaluation on company prediction. FIG. 8B provides an evaluation on title prediction.

### Results Segmented by Member's Seniority

The performance of each model with varying members' seniority in Computer is shown in FIGS. 8A and 8B, where the seniority is defined by the number of positions the member has in the training set.

This experiment shows the importance of the two design objectives: Career path modeling and Profile context matching. First, the benefit of considering career path is focused on. Context only model, which does not use career path at all, shows flat performance regardless of the number of positions observed, while all other methods achieve smaller error as more positions are observed. Moreover, the experiment shows that considering all career positions is better than using the last position only. The models using all positions (HRM, LSTM and NEMO) outperform the models using the last position only (MC and Bigram) as a member has more and more positions.

On the other hand, profile context is powerful for users with very few observed positions. Baselines using all career positions (LSTM and HRM) do not perform well for members with very few observed positions. For example, when a member has only one position observed, Context-only model outperforms all other baselines in both title prediction and company prediction. Since NEMO leverages profile attributes, it can outperform models solely based on career path significantly when a member has a very short history (i.e., cold-start case).

### Qualitative Analysis

Prediction case Study

In example embodiments, it may be determined that NEMO predicts next position accurately when other models cannot. Table 4 shows predictions for two members from NEMO and two baseline (Context-only, Bigram). The member's previous position (which is given to the model), current position (ground-truth), and the top five companies and the top five titles predicted by NEMO are shown.

For the user at the top row, it is found that he transitioned from an investment company to an airline company, which may be very hard to predict. Indeed, Bigram and Context Only models might not get the correct company even at the top 100. The reason for the NEMO model to be able to predict correctly is that this user has worked at an Airline company before, and LSTM model was able to “remember” that in the memory cell to make correct recommendations in the future, which was not possible for models that do not consider sequence. Moreover, NEMO leverages that the member has been working in Dallas, which helps narrow down to predicting Southwest Airlines.

For the second user, again, it is found that the user has worked at the same company, United States Patent and Trademark Office (USPTO), three positions before. Also the user has been working in the Washington, D.C. metro area and has information technology skills. In both cases, NEMO is able to provide accurate predictions due to its power to combine profile context as well as career trajectory.

TABLE 4
Example prediction case study for two users. Each user's
previous position, ground-truth next position, top five predicted companies and titles
is listed from left to right in the table. Bigram model ranks the Southwest Airlines at
125th place for the first user (top row) where Context Only method ranks it at 146th.
For second user (bottom row), Bigram ranks USPTO at 1319 whereas Context Only
ranks at it 395.

| | | Top 5 | |
|---|---|---|---|
| | Ground-truth next | recommended | Top 5 |
| Previous position | position | Company | recommended Title |
| Senior Project | Project Manager | Fidelity | Senior Project |
| Manager at Fidelity | at Southwest | Investments | Manager |
| Investments | Airlines | American Airlines | Project Manager |
| | | Southwest | Technical Project |
| | | Airlines | Manager |
| | | Epsilon | Senior Technical |
| | | Bank of America | Project Manager |
| | | | Program Manager |
| Software | Consultant at | Fannie Mae | Technical Lead |
| Architect/Tech | United States | USPTO | Senior Software |
| Lead at Bureau of | Patent and | FINRA | Engineer |
| Labor Statistics | Trademark Office | Lockheed Martin | Consultant |
| | | Freddie Mac | Senior Consultant |
| | | | Solutions Architect |

Sampling Career Path with NEMO

When LSTM is trained on natural text, sampling one word at a time may allow probing into what the model has learned about the text. In example embodiments, the model is trained on a professional's career path and one position at a time is sampled to form a career trajectory of a member. Now, suppose the model is input with a member at SF Bay area with skills “machine learning,” “data mining,” “artificial intelligence,” and “algorithms,” graduation from Carnegie Mellon University, and with a first job as Machine Learning Engineer at Google. The following sampled path is obtained: Machine Learning Engineer at WhatsApp Inc. Machine Learning Engineer at Uber→Data Scientist at Facebook→Engineering Lead at LinkedIn.

The model can also handle cold-start users for whom no prior working experience is observed. For instance, given a member having skills “Financial Services”. “Investments,” and graduation from Harvard Business School living in the Greater New York Area, the following sampled trajectory is obtained: Investment Banker at Citi→Technology Strategist at Citi→Relationship Manager at Citi→Vice President at Morgan Stanley→Vice President Brokerage at JPMorgan Chase. As can be seen, both members have a rising career trajectory. These sampled career trajectories can provide guidance to students in terms of university and major selections. Thus, NEMO can draw sample career trajectories given members' attributes since it handles both profile context and career sequence.

Thus, a contextual LSTM model (e.g., NEMO) may integrate profile context as well as career path dynamics. In example embodiments, the model follows the encoder-decoder architecture and can show significant improvements over strong baselines. Interpretable predictions may be provided by letting the model focus on different skills for different positions. In addition to the signals discussed above, other input signals may include skill endorsement graphs, connection graphs, following-follower graphs, attributes on the company's side (e. M/A, business area, locations, etc.).

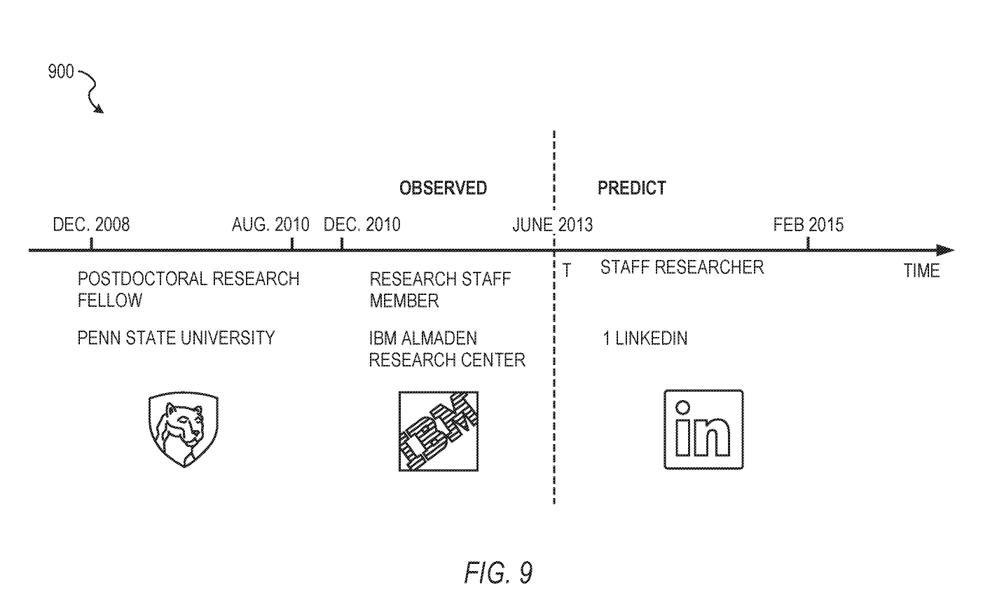

FIG. 9 is a screenshot of an example user interface 900. The user interface 900 shows working experience for one member of a social networking system. It can be seen that the member worked as a research staff member at IBM Almaden Research Center from December 2010 to June 2013. Suppose it is observed that the member's career history up to June 2013. The problem is to predict the member's next title and company after June 2013; that is, staff researcher at LinkedIn in this case. An application of the disclosed prediction system is used to solve this problem.

### Example Mobile Device

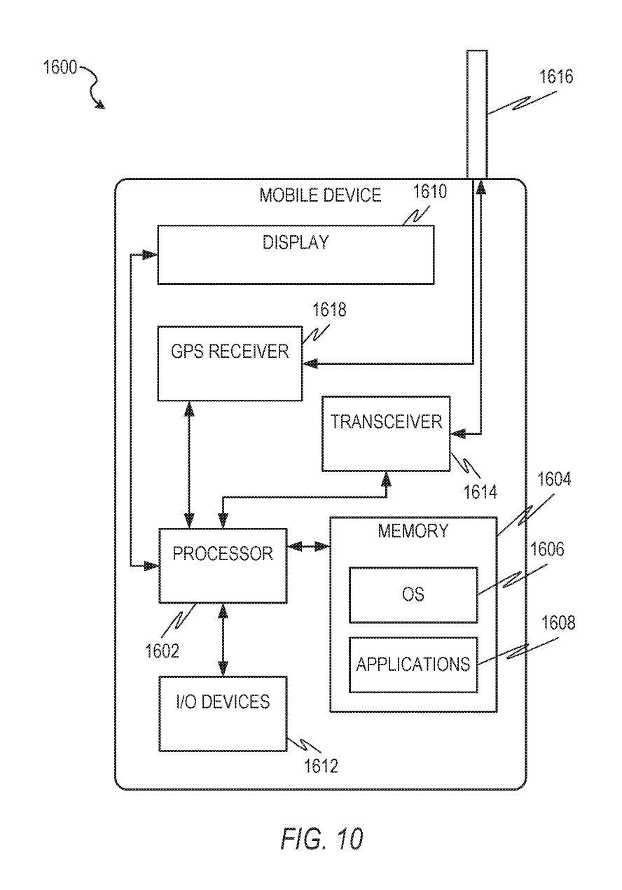

FIG. 10 is a block diagram illustrating a mobile device 1600, according to an example embodiment. The mobile device 1600 can include a processor 1602. The processor 1602 can be any of a variety of different types of commercially available processors suitable for mobile devices 1600 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 1600. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

in example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

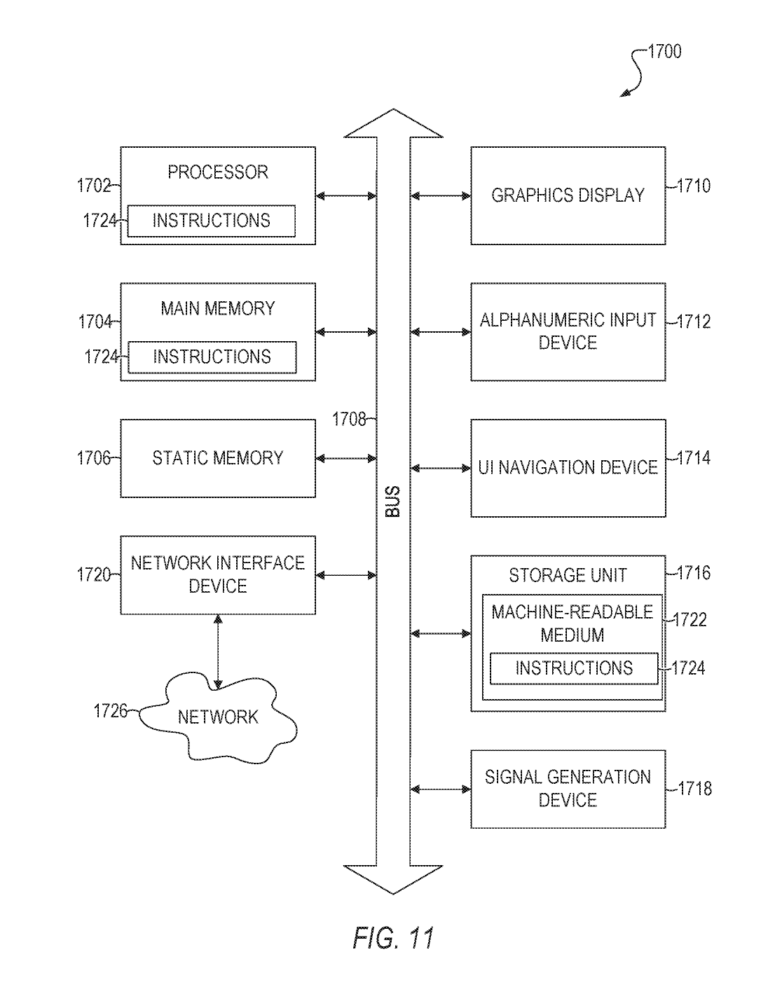

FIG. 11 is a block diagram of an example computer system 1700 on which methodologies described herein may be executed, in accordance with an example embodiment. In alternative embodiments, the machine operates as a standalone device or may be connected (e.g., networked) to other machines, in a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1700 includes a processor 1702 (e.g., a central processing unit (CPU), a graphics processing unit (GPU) or both), a main memory 1704 and a static memory 1706, which communicate with each other via a bus 1708. The computer system 1700 may further include a graphics display unit 1710 (e.g., a liquid crystal display (LCD) or a cathode ray tube (CRT)). The computer system 1700 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 1700, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
an encoder incorporated into the one or more computer memories, the encoder configuring the one or more computer processors to perform operations for encoding a representation of a user profile, the encoding including:
accessing discrete entities comprising context information included in the user profile;
constructing a plurality of embedding vectors from the context information, the plurality of embedding vectors including a skill embedding vector, a school embedding vector, and a location embedding vector, and
generating a context vector from the plurality of embedding vectors; and
a decoder incorporated into the one or more computer memories, the decoder configuring the one or more computer processors to perform operations for decoding a career path from the context vector, the decoding including applying a long short-term memory (LSTM) model to the context vector to generate a prediction of a user's next company and next title for presentation in a user interface.

2. The system of claim 1, wherein the encoding further includes using a pooling method to ensure that the context vector is in a same dimension as other context vectors corresponding to encodings for representations of other user profiles.

3. The system of claim 2, wherein a max-pooling method is selected as the pooling method based on measurements of accuracies of predictions generated by the decoder over a time period.

4. The system of claim 1, wherein the generating of the context vector includes taking a hyperbolic tangent of a concatenation of the plurality of embedding vectors.

5. The system of claim 1, wherein the decoding further includes applying an LSTM equation for deriving a dynamic representation of a user at a particular time point that aggregates the context information and a career history up to the particular time point.

6. The system of claim 1, further comprising one or more training modules incorporated into the one or more memories to configure the one or more computer processors to perform operations for training the LSTM model to maximize a probability of generating an accurate prediction given the context information.

7. The system of claim 6, wherein the training of the LSTM model includes using a sampled softmax strategy to improve scalability of the one or more training modules.

8. A method comprising:
incorporating an encoder into the one or more computer memories of a social networking system, the encoder configuring one or more computer processors to perform operations for encoding a representation of a user profile, the encoding including:
accessing discrete entities comprising context information included in the user profile;
constructing a plurality of embedding vectors from the context information, the plurality of embedding vectors including a skill embedding vector, a school embedding vector, and a location embedding vector, and
generating a context vector from the plurality of embedding vectors; and
incorporating a decoder into the one or more computer memories, the decoder configuring the one or more computer processors to perform operations for decoding a career path from the context vector, the decoding including applying a long short-term memory (LSTM) model to the context vector to generate a prediction of a user's next company and next title for presentation in a user interface.

9. The method of claim 8, wherein the encoding further includes using a pooling method to ensure that the context vector is in a same dimension as other context vectors corresponding to encodings for representations of other user profiles.

10. The method of claim 9, wherein a max-pooling method is selected as the pooling method based on measurements of accuracies of predictions generated by the decoder over a time period.

11. The method of claim 8, wherein the generating of the context vector includes taking a hyperbolic tangent of a concatenation of the plurality of embedding vectors.

12. The method of claim 8, wherein the decoding further includes applying an LSTM equation for deriving a dynamic representation of a user at a particular time point that aggregates the context information and a career history up to the particular time point.

13. The method of claim 8, further comprising one or more training modules incorporated into the one or more memories to configure the one or more computer processors to perform operations for training the LSTM model to maximize a probability of generating an accurate prediction given the context information.

14. The method of claim 13, wherein the training of the LSTM model includes using a sampled softmax strategy to improve scalability of the one or more training modules.

15. A non-transitory machine-readable storage medium embodying instructions that, when executed by one or more processors, cause the one or more processors to perform operations comprising:
accessing discrete entities comprising context information included in a user profile;
constructing a plurality of embedding vectors from the context information, the plurality of embedding vectors including a skill embedding vector, a school embedding vector, and a location embedding vector; and
generating a context vector from the plurality of embedding vectors;
generating a prediction of a user's next company and next title by applying a long short-term memory (LSTM) model to the context vector; and
presenting in a user interface the prediction of the user's next company and next title.

16. The non-transitory machine-readable storage medium of claim 15, the operations further comprising using a pooling method to ensure that the context vector is in a same dimension as other context vectors corresponding to encodings for representations of other user profiles.

17. The non-transitory machine-readable storage medium of claim 16, wherein a max-pooling method is selected as the pooling method based on measurements of accuracies of predictions generated by the decoder over a time period.

18. The non-transitory machine-readable storage medium of claim 15, wherein the generating of the context vector includes taking a hyperbolic tangent of a concatenation of the plurality of embedding vectors.

19. The non-transitory machine-readable storage medium of claim 15, wherein the operations further include applying an LSTM equation for deriving a dynamic representation of a user at a particular time point that aggregates the context information and a career history up to the particular time point.

20. The non-transitory machine-readable storage medium of claim 15, the operations further using one or more training modules to perform operations for training the LSTM model to maximize a probability of generating an accurate prediction given the context information.
